(19) United States
(12) Patent Application Publication
(10) Pub. No.: US 2009/0327344 A1
(43) Pub. Date: Dec. 31, 2009

(54) MEDIA FOUNDATION SOURCE READER

(75) Inventors: Matthew C. Howard, Bothell, WA (US); Stephen J. Estrop, Carnation, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/146,937

(22) Filed: Jun. 26, 2008

(51) Int. Cl. G06F 17/30

(52) U.S. Cl. 707/104.1; 707/E17.009

(57) ABSTRACT

Techniques are provided to allow developers to use a unified application programming interface to access multimedia data from different containers and in different formats.

### BACKGROUND

Various types of media, such as audio and video files, are often stored in logical containers in a data store. Applications which manipulate the media may use APIs to access a particular type of data from a particular type of container. For example, there are APIs to access AVI, ASF, and MP3 containers.

MICROSOFT® Media Foundation is one example of a framework providing APIs for accessing different multimedia containers.

### SUMMARY

Described herein are, among other things, techniques for providing access to both compressed and uncompressed multimedia data from a data store without requiring specific knowledge of the container structure or the media format.

In one implementation, an API is provided which allows an application to access multimedia data from various data sources, including AVI, WAV, ASF, MP3, and MPEG-4 containers without requiring the application to call into different APIs for each type of container for each type of container. In some implementations, the API may be extensible, so that additional container-types and file-types may be added.

### DESCRIPTION OF THE DRAWINGS

The detailed description provided below in connection with the appended drawings is intended as a description of example implementations and is not intended to represent the only forms in which a Media Foundation Source Reader may be implemented. The description sets forth the functions of example implementations and the sequence of steps for constructing and operating the examples. However, the same or equivalent functions and sequences may be accomplished by alternate implementations.

The present description will be better understood from the following detailed description read in light of the accompanying drawings, wherein:

FIG. 1 is an example of an operating environment in which a Media Foundation Source Reader may be implemented.

FIG. 2 is a block diagram of an example of a high level architecture for a Media Foundation Source Reader.

FIG. 3 is a flow chart of an example use of a Media Foundation Source Reader.

FIG. 4 illustrates a component diagram of a computing device according to one embodiment.

### DETAILED DESCRIPTION

Described herein are, among other things, examples of various technologies and techniques that allow simplified access to multimedia file content. Although the examples are described and illustrated herein as being implemented in a personal computer system, the system described is provided as an example and not a limitation. As those skilled in the art will appreciate, the present examples are suitable for application in a variety of different types of systems.

In the figures, like reference numerals are used throughout several drawings to refer to similar components.

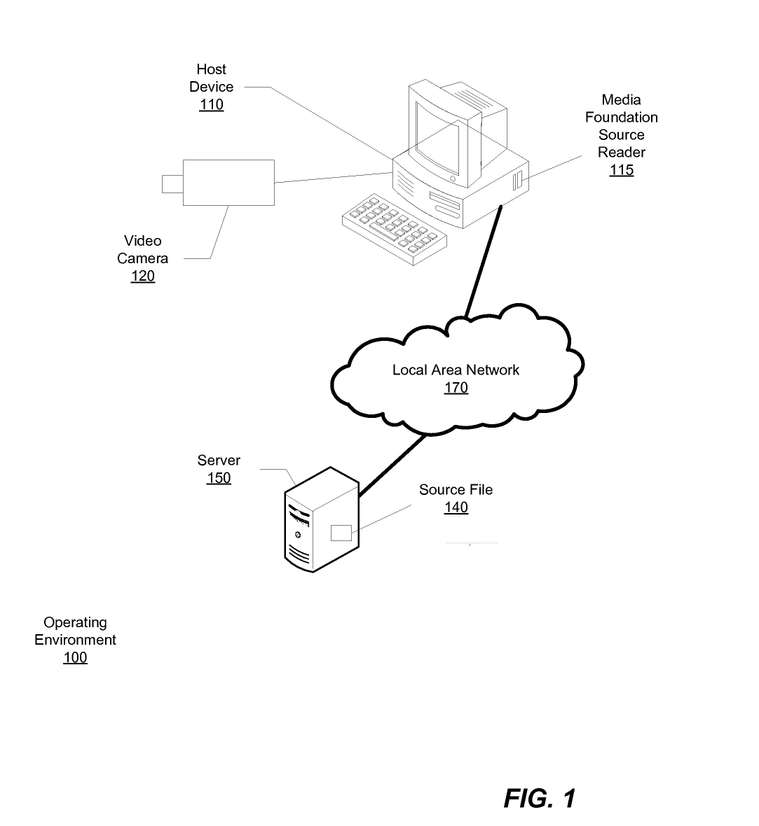

FIG. 1 is an example of an operating environment 100 in which a Media Foundation Source Reader may be implemented. Host device 110 has a Media Foundation Source Reader 115. Host device 110 is coupled to a video camera 120, which acts as a source for the Media Foundation Source Reader. Host device 110 is also coupled via local area network 170 to source file 140 disposed on a server 150, which also acts as a source for the Media Foundation Source Reader. While this example shows two possible sources, one skilled in the art would realize that many possible sources could be used, including, by way of example and not limitation, local files disposed on host device 110, files on removable or portable storage devices, webcams, digital video recorders, videotape recorders, or any other possible source of audio or video material.

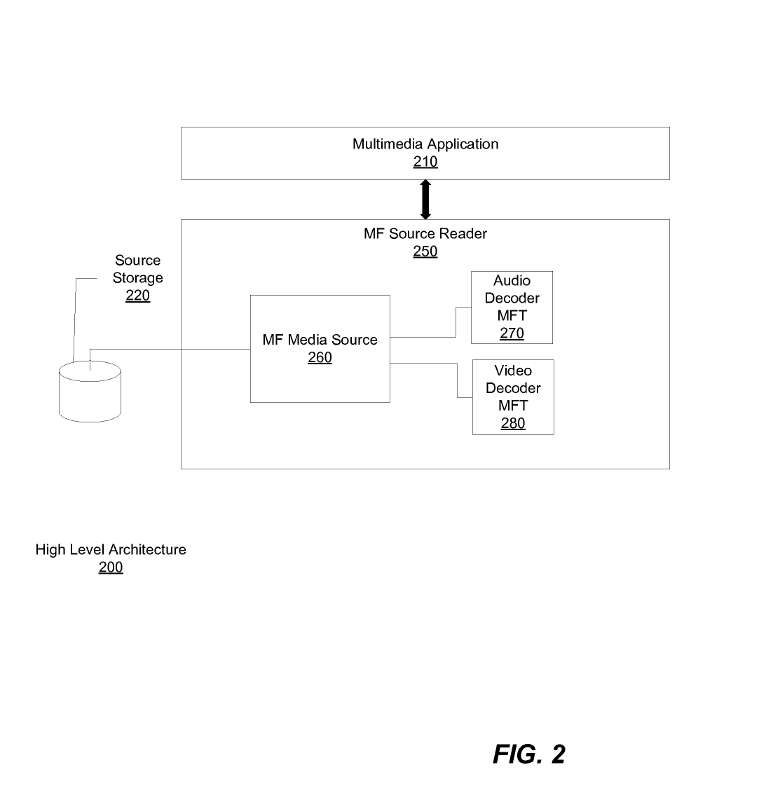

FIG. 2 is a block diagram illustrating an example of a high-level architecture 200 of a Media Foundation Source Reader (MF Source Reader). Multimedia Application 210 interacts with MF Source Reader 250 via standard APIs. MF Source Reader 250 includes a Media Foundation Media Source 260, which in this example reads from Source Storage 220. MF Source Reader 250 also includes Audio Decoder Media Foundation Transform (MFT) 270, and Video Decoder MFT 280. Audio and Video MFTs may include, by way of example and not limitation, audio and video codecs, audio and video effects, multiplexers, demultiplexers, decrypters, tees, color-space converters, sample-rate converters, and video scalers.

The MF Source Reader provides standard APIs for performing common tasks with multimedia content.

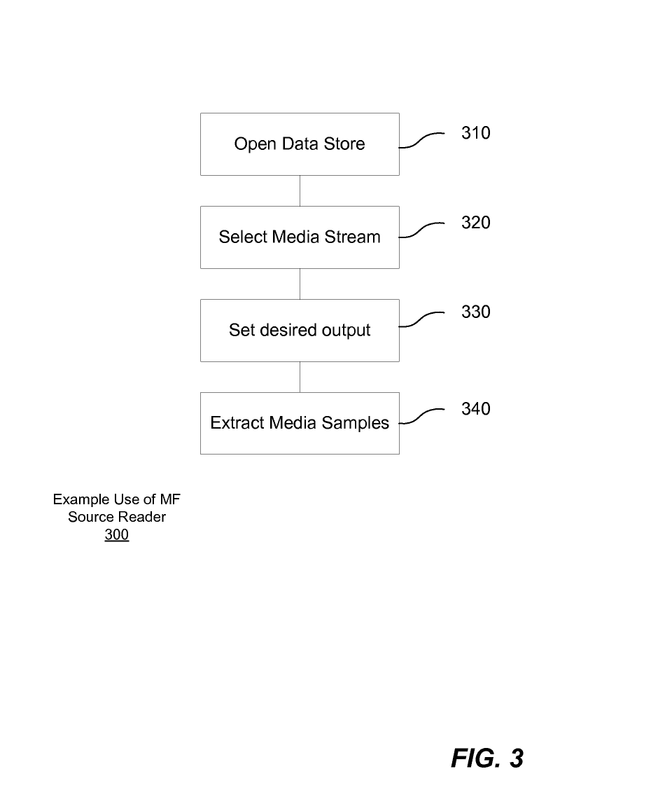

FIG. 3 is a flow chart 300 of an example use of a Media Foundation Source Reader. Multimedia Application 210 calls into a MF Source Reader to open 310 a multimedia data store. The multimedia data store contains several streams, so an API is called to select 320 from the available media streams. Even though the available media streams may have different formats, such as WMV, VC1, WMA, MP3, AVC (H.264), MPEG-4 video, AAC, PCM, YUV, RGB or others, a common API is provided by the MF Source Reader to select the media stream. A desired output media type is then selected 330 for the stream selected in step 320. The MF Source Reader is then ready to be called to extract 340 media samples.

In one embodiment, the MF Source Reader uses the MICROSOFT® Media Foundation (MF) framework to provide some of the functionality. In this example, the MF Source Reader uses an MF media source object to extract multimedia samples in their native format from a given file or device in a container-agnostic manner. It may use an MFT to convert compressed media into an uncompressed format. The MF Source Reader may also use the MF framework to determine which MFT to use to handle a specific container or format. For example, the MF Source Reader may call the MF MFTEnumEx API to find a suitable decoder based on the native media type for the particular stream it is to process.

In at least one implementation, the MF Source Reader will support asynchronous processing; in other implementations synchronous processing will be supported; while in others both synchronous and asynchronous modes will be supported.

In some implementations, the application may pass the source reader a URL which requires the source reader to open the data store. In other implementations, the application may pass in a bytestream interface to a previously opened data store. In yet another implementation, the application may pass in an instance of an MF media source which has already been configured with a data store. One skilled in the art may recognize that in various implementations, any combination of these or other techniques of indicating to the MF Source Reader an MF media source.

In some implementations, the MF Source Reader supports dynamic format changes. Such changes may be made, for example, in the media source or in the MFT, as well as changes that are initiated by the MFT used by the MF Source Reader itself. In some implementations the application can initiate a dynamic change in the format that is output from the reader, including, for example, changing from compressed to uncompressed or changing from one uncompressed format to another uncompressed format.

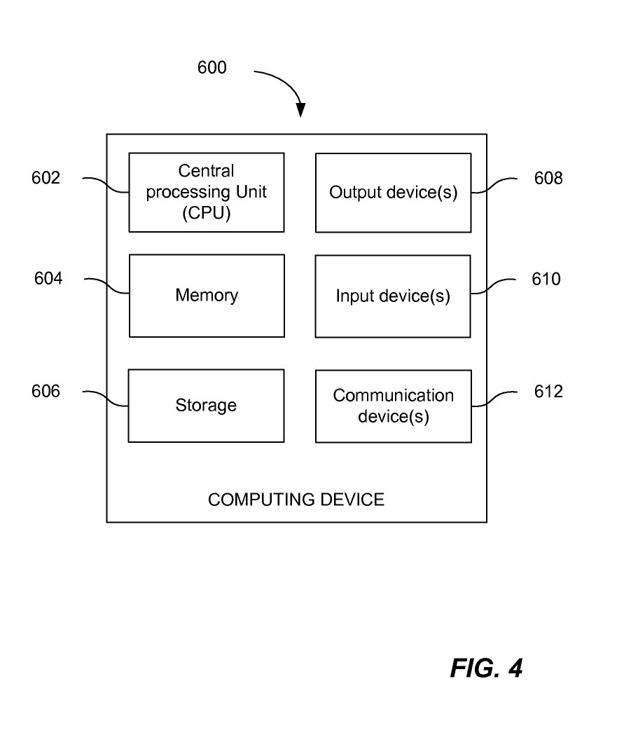

FIG. 4 illustrates a component diagram of a computing device according to one embodiment. The computing device 600 can be utilized to implement one or more computing devices, computer processes, or software modules described herein. In one example, the computing device 600 can be utilized to process calculations, execute instructions, receive and transmit digital signals. In another example, the computing device 600 can be utilized to process calculations, execute instructions, receive and transmit digital signals, receive and transmit search queries, and hypertext, compile computer code as required by Server 150 or Clients 110, 120, 130.

The computing device 600 can be any general or special purpose computer now known or to become known capable of performing the steps and/or performing the functions described herein, either in software, hardware, firmware, or a combination thereof.

In its most basic configuration, computing device 600 typically includes at least one central processing unit (CPU) 602 and memory 604. Depending on the exact configuration and type of computing device, memory 604 may be volatile (such as RAM), non-volatile (such as ROM, flash memory, etc.) or some combination of the two. Additionally, computing device 600 may also have additional features/functionality. For example, computing device 600 may include multiple CPU's. The described methods may be executed in any manner by any processing unit in computing device 600. For example, the described process may be executed by both multiple CPU's in parallel.

Computing device 600 may also include additional storage (removable and/or non-removable) including, but not limited to, magnetic or optical disks or tape. Such additional storage is illustrated in FIG. 6 by storage 206. Computer storage media includes volatile and nonvolatile, removable and non-removable media implemented in any method or technology for storage of information such as computer readable instructions, data structures, program modules or other data. Memory 604 and storage 606 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 600. Any such computer storage media may be part of computing device 600.

Computing device 600 may also contain communications device(s) 612 that allow the device to communicate with other devices. Communications device(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 600 may also have input device(s) 610 such as keyboard, mouse, pen, voice input device, touch input device, etc. Output device(s) 608 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for obtaining content from a multimedia data store comprising:
opening the multimedia data store;
selecting, without specifying a format, a first multimedia stream from the multimedia data store;
selecting a first desired output media type for the multimedia stream;
selecting, without specifying a format, a second multimedia stream comprising a different format than the first multimedia stream from the multimedia data store; and
extracting at least one multimedia sample from each of the multimedia streams.

2. The method of claim 1 wherein the first multimedia stream and second multimedia stream are the same multimedia stream.

3. The method of claim 1 wherein the format of the first multimedia stream is WMV.

4. The method of claim 1 further comprising dynamically selecting a second desired output media type for the multimedia stream.

5. The method of claim 1 further comprising processing at least one multimedia sample with a codec.

6. The method of claim 1 wherein the extracting at least one multimedia sample is performed asynchronously.

7. The method of claim 1 wherein the extracting at least one multimedia sample is performed synchronously.

8. A computer storage media having instructions disposed thereon that, when executed, execute the method of claim 1.

9. A system for obtaining content from a multimedia data store comprising:
a processor;
a memory coupled to the processor;
an opening module configured to open the multimedia data store;
a stream selecting module configured to select a multimedia stream from the multimedia data store;
a media type selecting module configured to select a desired output media type for the multimedia stream; and
an extracting module configured to extract multimedia samples from multimedia streams.

10. The system of claim 9 wherein the extracting module works asynchronously.

11. The system of claim 9 wherein the extracting module works synchronously.

12. The system of claim 9 further comprising a processing module configured to process the multimedia stream.

13. The system of claim 12 wherein the processing module comprises a codec module.

14. The system of claim 12 wherein the processing module comprises a video effects module.

15. A method to provide a common programming interface for multimedia stream access to an application, comprising:
an application programming interface to open a data store;
an application programming interface to open a multimedia stream from the data store;
